(19) United States
(12) Patent Application Publication
(10) Pub. No.: US 2025/0348710 A1
(43) Pub. Date: Nov. 13, 2025

(54) AUTOMATED GENERATION OF A DATASET OF QUESTION-ANSWER PAIRS FOR DOMAIN-SPECIFIC HALLUCINATION TESTING OF GENERATIVE LANGUAGE PROCESSING MACHINE LEARNING MODELS

(71) Applicant: INTUIT INC., Mountain View, CA (US)

(72) Inventors: Tharathorn RIMCHALA, San Francisco, CA (US); Nazanin Zaker HABIBABADI, Sunnyvale, CA (US); Nikhil VASUDEVA, San Jose, CA (US); Runhua ZHAO, San Jose, CA (US); Xiaofeng WANG, Mountain View, CA (US)

(21) Appl. No.: 18/661,925

(22) Filed: May 13, 2024

(51) Int. Cl. G06N 3/0455

(52) U.S. Cl. CPC G06N 3/0455

(57) ABSTRACT

Aspects of the present disclosure provide techniques for automated generation of a dataset of question-answer pairs for domain-specific hallucination testing of generative language processing machine learning models. Embodiments include providing a first block of natural language text from a domain-specific source document as an input to each of a plurality of question-answer pair generation models. Embodiments include obtaining one or more confidence metrics for each of the plurality of question-answer pairs generated by each of a plurality of question-answer pair generation models. Embodiments include filtering one or more question-answer pairs based on the one or more confidence metrics generated for the one or more question-answer pairs. Embodiments include generating a dataset for domain-specific hallucination testing of a generative language processing machine learning model based on the filtering.

### INTRODUCTION

Aspects of the present disclosure relate to techniques for automatically generating a dataset of question-answer pairs for domain-specific hallucination testing of generative language processing machine learning models.

### BACKGROUND

Every year millions of people, businesses, and organizations around the world utilize software applications to assist with countless aspects of life. Many software applications may utilize artificial intelligence (e.g., in the form of language models) to generate automated responses to natural language queries submitted by users.

Generative language processing machine learning models, such as large language models (LLMs), are trained with data from a variety of sources and generally provide automated responses that are consistent based on the natural language queries received from users. However, generative language processing machine learning models may generate hallucinations in some cases. A hallucination occurs when an automated response generated by a generative language processing machine learning model includes false, misleading, inaccurate, or outdated information. For example, a user may ask the generative language processing machine learning model a question, and the generative language processing machine learning model may generate an automated response that may sound convincing but is actually incorrect.

It can be difficult to detect when hallucinations occur, either manually (e.g., due to the convincingness of hallucinatory content) or automatically (e.g., due to the lack of source of truth against which to automatically compare such content). This difficulty can drastically limit the utility of generative language processing machine learning models to only low-risk, low-impact use cases. For example, if a generative language processing machine learning model generates false information, then users may not be able to rely on content generated by the generative language processing machine learning model unless they first verify the accuracy of the content. When users are required to manually verify the outputs of the generative language processing machine learning model, much of the convenience and efficiency of using the generative language processing machine learning model to automatically generate content may be lost. Existing technological solutions for preventing hallucinations may involve manually detecting hallucinations and then modifying the prompts and/or re-training generative language processing machine learning models to reduce and/or eliminate hallucinations. Such re-training and modification of the generative language model may often be impractical for particular users and/or particular applications. For example, automated responses generated by a generative language processing machine learning model that are domain specific can only be verified by an individual having knowledge and expertise in that specific domain.

Accordingly, techniques are needed for generating datasets that can be used to automatically perform domain-specific hallucination tests of generative language processing machine learning models.

### BRIEF SUMMARY

Certain embodiments provide a method for automatically generating a dataset of question-answer pairs for domain-specific hallucination testing of generative language processing machine learning models. The method generally includes: extracting natural language text from a domain-specific source document as a plurality of blocks of natural language text; providing a first block of natural language text of the plurality of blocks of natural language text as an input to each of a plurality of question-answer pair generation models, each of the question-answer pair generation models configured to generate a plurality of question-answer pairs from the first block of natural language text; obtaining one or more confidence metrics for each of the plurality of question-answer pairs generated by each of the plurality of question-answer pair generation models; filtering one or more question-answer pairs included in the plurality of question-answer pairs generated by one or more of the plurality of question-answer pair generation models based, at least in part, on the one or more confidence metrics generated for the one or more question-answer pairs; and generating a dataset for domain-specific hallucination testing of a generative language processing machine learning model based on the filtering, the dataset comprising question-answer pairs remaining in the plurality of question-answer pairs after the filtering.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a system for automatically generating question-answer pairs for domain specific hallucination testing of generative language processing machine learning models, according to certain aspects of the present disclosure.

FIG. 2 depicts a flow diagram of an example method for automatically generating question-answer pairs for domain-specific hallucination testing of generative language processing machine learning models, according to certain embodiments.

FIG. 3 depicts a technique for automatically generating question-answer pairs for different portions of a source document, according to certain aspects of the present disclosure.

FIG. 4 depicts text extracted from a source document in blocks of text, according to certain embodiments.

FIG. 5 depicts a non-large language model generating question answer pairs for information included in a portion of a domain-specific source document, according to certain embodiments.

FIG. 6 depicts a large language model generating question answer pairs for information included in a portion of a domain-specific source document, according to certain embodiments.

FIG. 7 depicts an example processing system for automatically generating question-answer pairs for domain-specific hallucination testing, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating datasets for hallucination testing of generative language processing machine learning models.

Hallucinations of generative language processing machine learning models in the form of false or misleading answers to questions within a specific domain (e.g., science, medicine, law, finance) can only be verified manually, such as by an individual having expertise within the specific domain. Manually verifying such hallucinations is impractical given the large number of questions that a generative language processing machine learning model can be asked within the specific domain.

Example aspects of the present disclosure are directed to using an ensemble of multiple machine learning models to automatically generate question-answer pairs from domain-specific source documents and, for each of the generated question-answer pairs, determining one or more confidence scores that can be used to filter (e.g., remove question-answer pairs having a confidence score below a threshold confidence score) the question-answer pairs to generate a dataset of question-answer pairs that can be used to automatically perform domain-specific hallucination testing of another machine learning model, such as a generative language processing machine learning model. Thus, techniques disclosed herein allow question-answer pairs for domain-specific hallucination testing to be automatically generated while reducing incorrect or hallucinatory question-answer pairs in domain-specific hallucination testing.

To generate the dataset, factually correct content (e.g., natural language text) may be extracted from multiple reliable source documents (e.g, blog posts from trusted authors, product announcements, news articles, user guides, instruction manuals). Each of the source documents may come from a trusted source and includes content related to a specific domain of knowledge (e.g., science, medicine, law, finance). Furthermore, each source document may cover multiple topics and/or include multiple sections. Therefore, the extracted content may, in such instances, be preprocessed to organize (e.g., split) the extracted content into multiple different blocks of content (e.g., of varying length), with each block of text corresponding to a different topic/section of the source document.

In some instances, one or more of the source documents may be a structured document having identifiers indicative of different sections of the structured document. For example, the structured document may be a HyperText Markup Language (HTML) web page, and the identifiers indicative of different sections of the HTML web page may be tags associated with the HTML code for the web page. Therefore, for a structured document, extracted content may be organized (e.g., split) into blocks of content (e.g., complete paragraphs), with each block of text corresponding to a different section of the structured document.

In some instances, one or more of the source documents may be an unstructured document (e.g., scanned page of a textbook). The unstructured document may, in contrast to structured documents, lack identifiers indicative of the different sections of the unstructured document. Therefore, a machine learning model trained to dynamically identify topic changes that occur within the unstructured document may be used to organize the extracted content from the unstructured document into the multiple blocks of text. More specifically, the extracted content from the unstructured document may be provided as an input to the machine learning model, and the machine learning model may process the extracted content to identify topic changes occurring within the extracted content. In some instances, the machine learning model may organize (e.g., split) the extracted content into the multiple different blocks of content. In other instances, the machine learning model may add identifiers to the extracted content that represent topic changes within the extracted content and may output the modified content (e.g., including the identifiers). Then, the modified content may be organized into the multiple blocks of content based on the identifiers added by the machine learning model and indicative of topic changes within the extracted content.

Each block of extracted content may be provided to the question-answer pair generation module. In some instances, the question-answer pair generation module may provide each block of extracted content to a plurality of different large language processing machine learning models (e.g., referred to as LLMs). Each of the LLMs may be configured to generate a plurality of question-answer pairs for each block of extracted content. For example, each of the LLMs may receive the extracted content as an input and may be prompted to generate a plurality of question-answer pairs based on the extracted content.

To provide more robust question-answer pairs for domain-specific hallucination testing, the question-answer pair generation module may, in some instances, also provide each block of extracted content to a non-LLM trained to generate question-answer pairs. The extracted content may be provided as an input to the non-LLM and the non-LLM may generate question-answer pairs for the extracted content in addition to the question-answer pairs generated by each of the LLMs.

As used herein, the term “non-LLM” refers to a language processing machine learning model that, unlike each of the LLMs, cannot accept natural language prompts like each of the LLMs. Furthermore, the question-answer pairs generated by the non-LLM may be less diverse compared to the question-answer pairs generated by the LLMs. However, since the non-LLM is trained to generate question-answer pairs that are grounded in the input, the question-answer pairs generated by the non-LLM may be less likely to include a hallucination. In this manner, adding question-answer pairs generated by the non-LLM may allow the dataset of question-answer pairs for domain-specific hallucination testing to be grounded in the trusted source document and much less from the internal knowledge of the LLMs learning from internal scale data with varying trustworthiness of the source document.

Hallucination testing may include providing a generative language processing machine learning model a question that the generative language processing machine learning model does not have enough information to answer. To that end, the disclosed techniques may include modifying a question-answer pair (e.g., automatically generated by the non-LLM or one of the LLMs) to represent an unanswerable question in the given domain. For example, the question may include an entity (e.g., person, place, or object), and the question may be modified to swap the entity with another entity. Alternatively, or additionally, one or more words in the question may be modified using an antonym replacement technique in which the one or more words are replaced with their antonym. In some instances, the answer for the now unanswerable question may be synthetically created based on answers included in an existing refusal response library. In this manner, the answer included in the question-answer pair may be updated to reflect an appropriate (e.g., boilerplate) answer to the now unanswerable question.

To ensure a diverse set of question-answer pairs are generated for a respective block of extracted content, one or more confidence metrics may be generated for each question-answer pair. For example, the one or more confidence metrics may include a confidence score for each question generated by a respective LLM and a confidence score for each answer generated by the respective LLM. Additionally, the one or more confidence metrics may include a difficulty rating (e.g., very easy, easy, medium, hard, very hard) for each respective question-answer pair.

The question-answer pairs automatically generated for a block of text may be consolidated based on different filtering criteria (e.g., consistency, confidence). To filter based on confidence, a confidence metric associated with a respective question-answer pair may be compared against a threshold confidence metric. If the confidence metric does not satisfy (e.g., is below) the threshold confidence metric, the question-answer pair may be considered unreliable and therefore may be automatically removed from the plurality of question-answer pairs. The confidence metric associated with the respective question-answer pair may include, for example, a confidence score associated with the question of the respective question-answer pair and/or a confidence score associated with the answer of the respective question-answer pair.

After removing question-answer pairs having a confidence metric that is below the threshold confidence metric, the remaining question-answer pairs may be provided as an input to an embedding model trained to generate an embedding of each respective question-answer pair in an embedding space. An embedding generally refers to a vector representation of a question-answer pair that represents the question-answer pair as a vector in n-dimensional space such that similar question-answer pairs are represented by vectors that are close to one another in the n-dimensional space. In this manner, multiple question-answer pairs having embeddings that are close to one another in the n-dimensional space may be considered a group of similar question-answer pairs. For example, the embedding model may compute cosine similarity values for the different vectors to determine whether two or more of the vectors (e.g., embeddings) are similar to one another.

In some instances, an embedding for a question-answer pair may not be close to any of the other embeddings in the n-dimensional space. In such instances, the question-answer pair may be removed from the plurality of question-answer pairs because, although the question-answer pair satisfies one filtering criteria (e.g., confidence), the question-answer pair does not satisfy the additional filtering criteria (e.g., consistency). Therefore, the question-answer pair will be removed from the plurality of question-answer pairs.

Within a group of similar question-answer pairs (e.g., determined based on the embeddings), each respective answer included in the group may be provided to an entailment model. The entailment model may be trained to assess a logical relationship between two sentences. Thus, for example, the entailment model may assess an entailment (e.g., logical relationship) between two different answers included in the group of similar question-answer pairs. In addition, the entailment between the two different answers within the group of similar question-answer pairs may be compared to a similarity threshold to identify one or more question-answer pairs within the group of similar question-answer pairs that may, based on the measured entailment, be unreliable for domain-specific hallucination testing. If the entailment between the two different answers within the group of similar question-answer pairs does not satisfy (e.g., is below) the similarity threshold, the group of similar question-answer pairs may be unreliable and therefore may be excluded from the dataset of question-answer pairs for domain-specific hallucination testing. Otherwise, the group of similar question-answer pairs may be considered reliable and therefore may be included in the dataset of question-answer pairs for domain-specific hallucination testing.

In some instances, domain-specific hallucination testing of a generative language processing machine learning model may be performed using the automatically generated dataset of question-answer pairs. For instance, a question from a respective question-answer pair of the dataset may be provided as an input to the generative language processing machine learning model. The generative language processing machine learning model may output an answer to the question. In some instances, an embedding may be generated of the answer output by the generative language processing machine learning model. The embedding of the answer output by the generative language processing machine learning model may then be compared to an embedding of the answer that is associated with the question in the dataset (and/or, in some embodiments, embeddings of one or more other answers in the dataset). If the embedding of the answer output by the generative language processing machine learning model is not similar to any of the embeddings of the answers included in the dataset, the answer generated by the generative language processing machine learning model may be considered a hallucination.

Example aspects of the present disclosure provide numerous technical effects and benefits. For instance, by using a plurality of LLMSs to generate question-answer pairs from source documents that are trusted and domain-specific, a dataset for domain-specific hallucination testing may be automatically generated. Furthermore, by automatically filtering the generated question-answer pairs based on confidence and consistency, question-answer pairs that may represent a hallucination can be automatically excluded from the dataset of domain-specific question-answer pairs for hallucination testing. In this manner, the disclosed techniques automatically exclude unreliable question-answer pairs and therefore prevent such question-answer pairs from being used to perform hallucination testing on generative language processing machine learning models. Advantageously, by enabling automated generation of the dataset for domain-specific hallucination testing while ensuring the dataset itself does not contain hallucinations, techniques described herein allow hallucination testing to be performed on generative language processing machine learning models in an accurate and efficient manner at scale, thereby effectively identifying models that generate hallucinations so that action can be taken to prevent and/or mitigate such hallucinations. Accordingly, embodiments of the present disclosure improve the technical field of hallucination testing in generative language processing machine learning models and improve the functioning of generative language processing machine learning models themselves. Additionally, by utilizing language processing machine learning models to generate question-answer pairs based on domain-specific source documents while performing automated processes to identify and exclude unreliable question-answer pairs, techniques described herein allow such source documents, which may not be natively formatted in such a manner as to be used for hallucination testing, to be used for generating the dataset of question-answer pairs in a format usable for hallucination testing while preventing such datasets from themselves including hallucinations.

### Example Technique for Automated Generation of Question-Answer Pairs for Hallucination Testing of Generative Language Processing Machine Learning Models

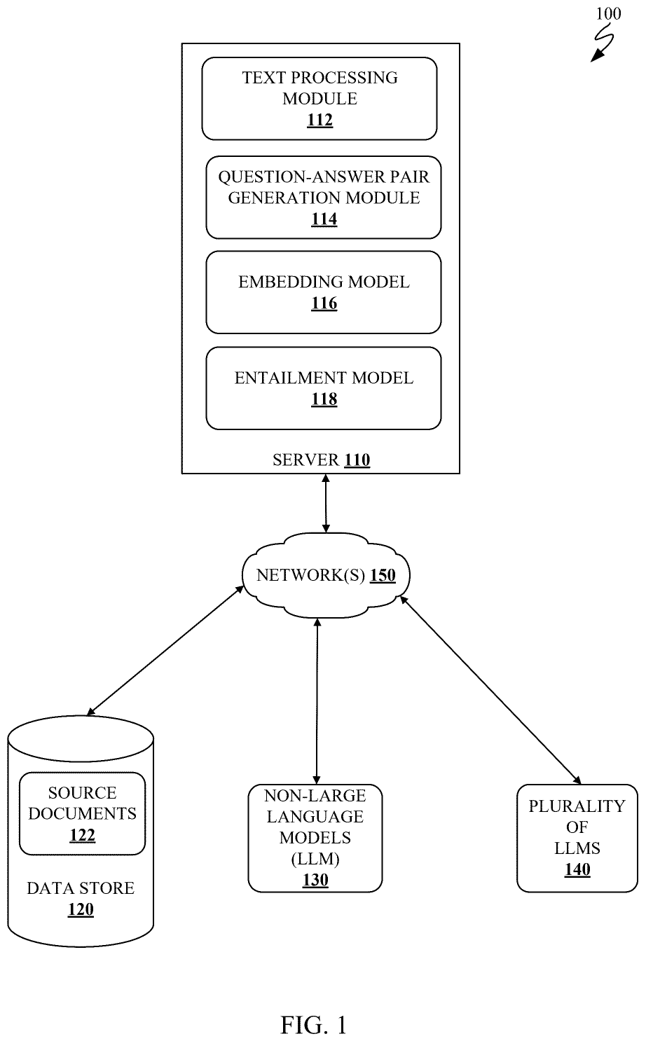

FIG. 1 illustrates an example system 100 for automatically generating a dataset of question-answer pairs for domain-specific hallucination testing of generative language processing machine learning models, according to certain embodiments.

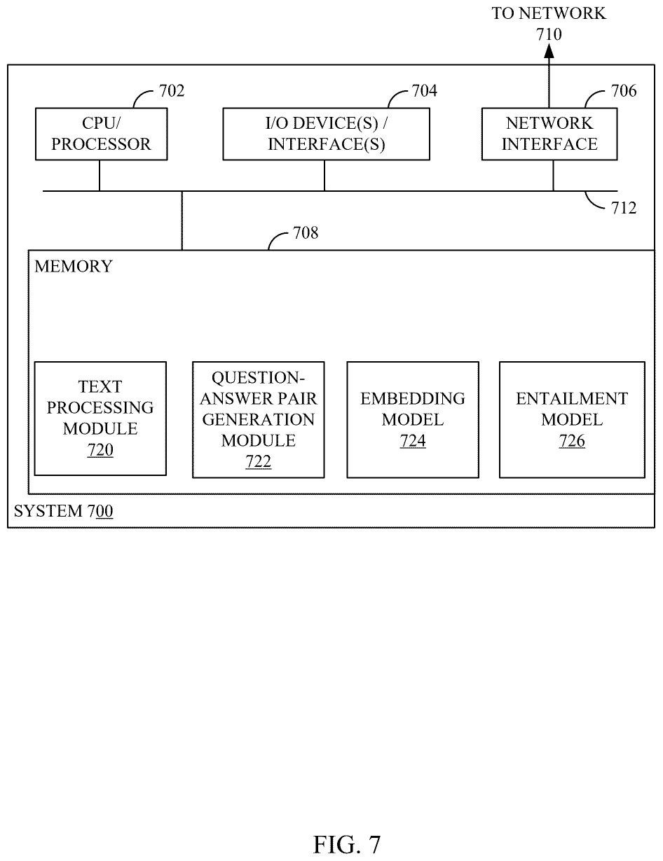

The system 100 includes a server 110, which may be implemented via one or more physical computing devices, such as the computing system discussed below with respect to FIG. 7. The server 110 may be communicatively coupled with a data store 120, a non-LLM 130 (e.g., a neural network), and a plurality of LLMs 140 via one or more networks 150. The network(s) 150 may include, without limitation, a wide area network (WAN), a local area network (LAN), and/or a cellular network, and more generally may include any wired or wireless connection over which data may be communicated.

The non-LLM 130 may be trained to generate question-answer pairs based on input (e.g., natural language text). Examples of the non-LLM 130 may include, without limitation, a text-to-text transfer transformer (t5) based language model that is trained end to end. Each of the LLMs 140 may be prompted to generate question-answer pairs based on input (e.g., natural language text) and, in contrast to the non-LLM 130, may be prompted to generate various indicators (e.g., difficulty rating, confidence score) for each respective question-answer pair. Examples of the LLMs 140 may include, without limitation, third-party or open source LLMs, such as ChatGPT, LLAMA2-7B, Mistral-7B, OpenOrca, and Zephyr-7B.

The server 110 may include a text processing module 112, a question-answer pair generation module 114, an embedding model 116, and an entailment model 118. These individual components may be implemented as a pipeline architecture to: (1) automatically extract content included in source documents 122 (e.g., stored on data store 120); (2) automatically generate question-answer pairs from the extracted content (e.g., using the non-LLM 130 and the plurality of LLMs 140); and (3) automatically filter the question-answer pairs (e.g. using the embedding model 116 and the entailment model 118) to generate one or more datasets of question-answer pairs for domain-specific hallucination testing of a language processing machine learning model.

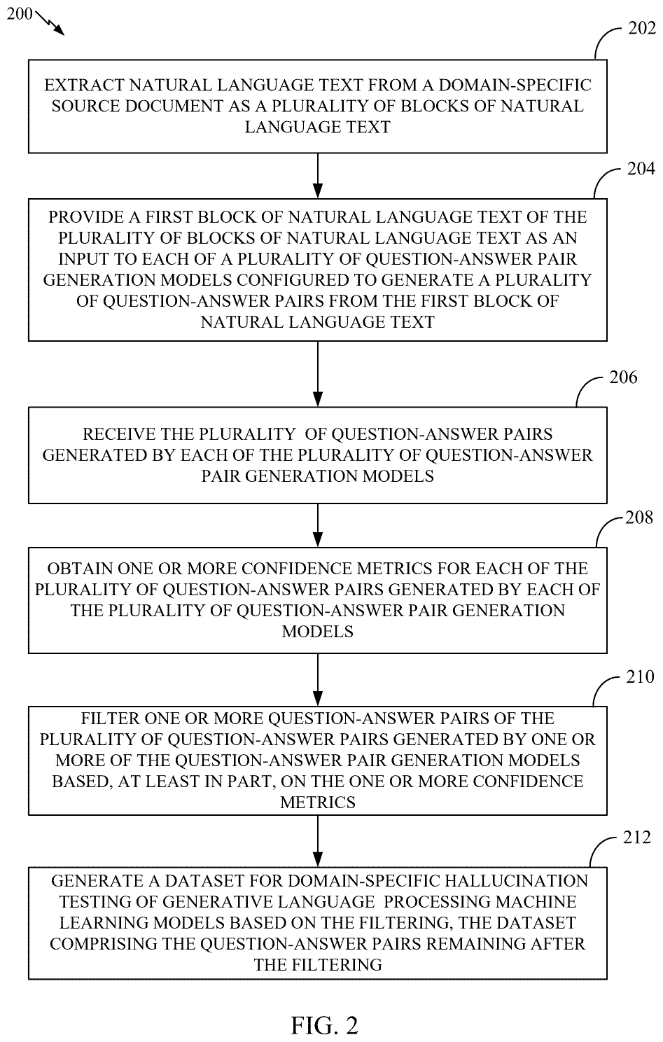

Although the text processing module 112, the question-answer pair generation module 114, the embedding model 116, and the entailment model 118 are depicted as being included on the server 110, it should be appreciated that, in some embodiments, one or more of these components may be executed on another device (e.g., another server) that is remote relative to the server 110. Operations of components depicted in FIG. 1 are described in more detail below with respect to FIG. 2.

### Example Method for Automatically Generating Question-Answer Pairs for Domain-Specific Hallucination Testing

FIG. 2 is a flow diagram of an example set of operations 200 for automatically generating a dataset (e.g., question-answer pair) for domain-specific hallucination testing, according to some embodiments of the present disclosure. The operations 200 may be performed by instructions executing on a processor of a server (such as the server 110 of FIG. 1).

Operation 202 includes extracting natural language text from a domain-specific source document as a plurality of blocks of natural language text. For example, operation 202 may be performed by a text processing module (e.g., the text processing module 112 illustrated in FIG. 1).

Operation 204 includes providing a first block of natural language text of the plurality of blocks of natural language text as an input to each of a plurality of question-answer pair generation models (e.g., the non-LLM 130 illustrated in FIG. 2 and/or one or more of the LLMs 140 illustrated in FIG. 2).

Operation 206 includes receiving the plurality of question-answer pairs generated by each of the question-answer pair generation models.

Operation 208 includes obtaining one or more confidence metrics for each of the plurality of question-answer pairs generated by each of the plurality of question-answer pair generation models.

Operation 210 includes filtering one or more question-answer pairs included in the plurality of question-answer pairs generated by one or more of the question-answer pair generation models based, at least in part, on the one or more confidence metrics generated for the one or more question-answer pairs. In this manner, a question-answer pairs having a low confidence metric, which may be an indication of an unreliable question-answer pair, can be automatically excluded from a dataset of question-answer pairs for domain-specific hallucination testing of generative language processing machine learning models that is generated at operation 614.

### Technique for Automatically Generating Question-Answer Pairs for Domain-Specific Hallucination Testing

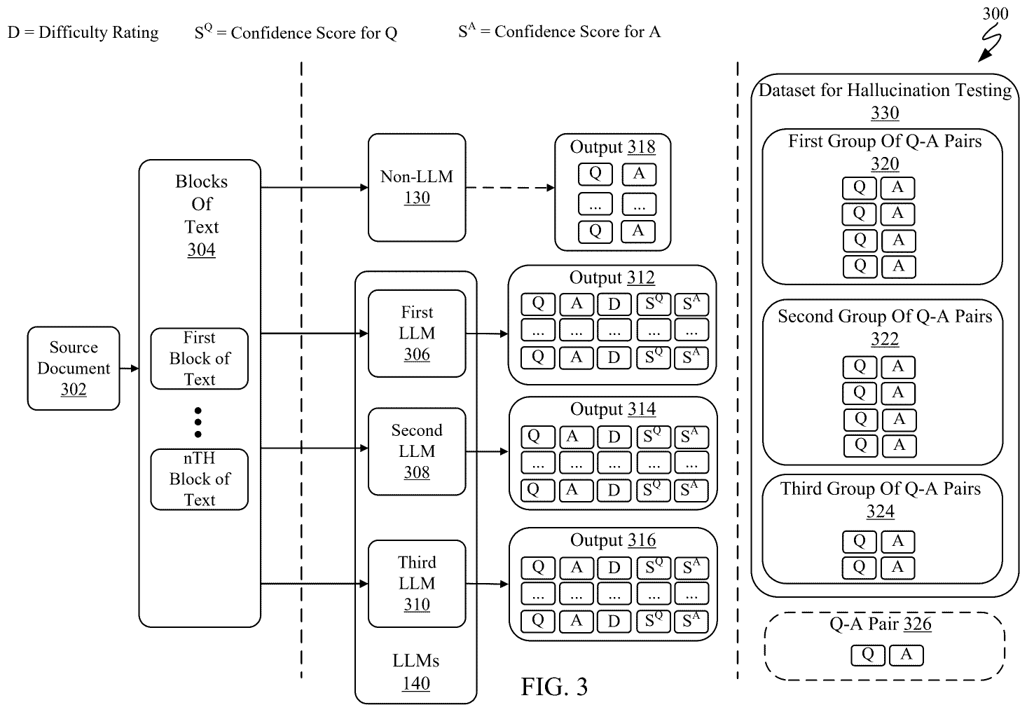

FIG. 3 is a diagram 300 illustrating a plurality of question-answer pairs being generated for content extracted from a source document 302, according to some embodiments of the present disclosure. It should be understood that the source document 302 may be included in the plurality of source documents 122 discussed above with reference to FIG. 1 and may include any suitable type of electronic document (e.g., web page, scanned page(s) of a textbook).

A text processing module (e.g., the text processing module 112 illustrated in FIG. 1) may process the source document 302. For example, the text processing module may extract text from the source document 302 as a plurality of blocks of text 304. Furthermore, each of the blocks of text 304 may correspond to a different section/topic of the source document 302.

A question-answer pair generation module (e.g., the question-answer pair generation module 114 illustrated in FIG. 1) may provide the plurality of blocks of text 304 as an input to each of the plurality of LLMs 140. For example, the question-answer pair generation module may provide the plurality of blocks of text 304 as an input to a first LLM 306 of the LLMs 140, a second LLM 308 of the LLMs 140, and a third LLM 310 of the LLMs 140. It should be understood that, in alternative embodiments, the plurality of LLMs 140 may include more or fewer LLMs than illustrated in FIG. 3. The question-answer pair generation module may, in some embodiments, also provide the plurality of blocks of text 304 to the non-LLM 130.

Each of the plurality of LLMs 140 may be prompted to generate a plurality of question-answer pairs in parallel for each respective block of text included in the plurality of blocks of text 304. For example, an output 312 of the first LLM 306 for a respective block of text (e.g., first block of text) that is provided as an input to the first LLM 306 may include a plurality of question-answer pairs (e.g., illustrated as multiple rows of Q-A). Likewise, an output 314 of the second LLM 308 and an output 316 of the third LLM 310 for the respective block of text that is provided as an input to the second LLM 308 and the third LLM 310 may include a plurality of question-answer pairs. Also, an output 318 of the non-LLM 130 for the respective block of text provided as an input to the non-LLM 130 may include a plurality of question-answer pairs.

To ensure the plurality of LLMs 140 generate a diverse set of question-answer pairs for a respective block of text, each of the LLMs 140 may be prompted (e.g., via the question-answer pair generation module) to generate one or more confidence metrics for each respective question-answer pair. For example, a generated prompt may instruct each of the LLMs 140 to assign a difficulty rating (e.g., labeled as D in output 312, 314, 316) to each respective question-answer pair. The difficulty rating may, for example, be selected from one of a plurality of different ratings (e.g., very easy, easy, medium, hard, very hard). In some embodiments, the difficulty rating may correspond to a numerical value in a range of numerical values (e.g., 0 to 9) with the lowest numerical value in the range of numerical values corresponding to very easy and the highest numerical value in the range of numerical values corresponding to very hard. Alternatively, or additionally, a generated prompt may instruct each of the LLMs 140 to determine a confidence score (e.g., labeled as SQ in outputs 312, 314, 316) for a question of a respective question-answer pair and a confidence score (e.g., labeled as SA in output 312, 314, 316) for an answer of a respective question-answer pair.

The non-LLM 130 generally represents a neural network that, unlike the LLMs 140, does not possess the ability follow free form natural language instructions. Therefore, the non-LLM 130 may be unable to generate a difficulty rating for a respective question-answer pair. However, confidence scores for a question of a respective question-answer pair may be derived from the non-LLM 130 by aggregating the “token level confidence score” of the tokens in the question and the answer, respectively.

In some embodiments, the question-answer pair generation module may determine confidence metrics (e.g., confidence score) associated with a question in a question-answer pair generated by the non-LLM 130 for a respective block of text (e.g., first block of text). For instance, the question included in the question-answer pair may be a sentence including a plurality of words, with each word corresponding to one or more tokens. Furthermore, each of the tokens may have a probability value that is conditional based on a probability of the token that immediately precedes the current token. Thus, in some embodiments, the question-answer pair generation module may aggregate a conditional probability of each of the tokens associated with the question of the question-answer pair to generate a confidence score for the question. The question-answer pair generation module may determine a confidence score associated with an answer in a question-answer pair generated by the non-LLM 130 in the same manner as discussed for the question of the question-answer pair.

In some embodiments, a question-answer pair automatically generated for a respective block of text may be unreliable. For example, the question-answer pair automatically generated for the respective block of text may represent a hallucination of the model (e.g., the non-LLM 130 or one of the LLMs 140) that generated the question-answer pair. In some instances, a question-answer pair having a confidence score that does not satisfy (e.g., is below) a threshold confidence score may be determined to be unreliable. The question-answer pair may therefore be automatically removed (e.g., discarded) from the plurality of question-answer pairs generated for the respective block of text so that the question-answer pair is not included in a dataset 330 of question-answer pairs for domain-specific hallucination testing.

After filtering out the question-answer pairs having a confidence score that does not satisfy the threshold confidence score, embeddings of each of the remaining question-answer pairs may be generated. For example, the question-answer pair generation module may provide the remaining question-answer pairs as an input to an embedding model (e.g., the embedding model 116 illustrated in FIG. 1). The embedding model may be trained to generate an embedding of each respective question-answer pair in an embedding space.

In some embodiments, a similarity measure (e.g., a cosine similarity) between embeddings for different question-answer pairs can be computed to determine whether the different question-answer pairs are similar. For instance, the different question-answer pairs can be considered to be in a group if the computed cosine similarity is within a similarity threshold value. For example, as illustrated in FIG. 3, different groups of question-answer pairs may be identified based on the embeddings of the plurality of question-answer pairs generated from the respective block of text. For instance, the identified groups of question-answer pairs may include a first group 320 having four question-answer pairs, a second group 322 having four question-answer pairs, and a third group 324 having two question answer-pairs.

In some embodiments, the plurality of question-answer pairs may include a question-answer pair 326 having a confidence score that satisfies the threshold confidence score yet is not similar to any other question-answer pair included in the plurality of question-answer pairs. More specifically, the question-answer pair 326 may not be similar to the question-answer pairs included in any of the first group 320, the second group 322, or the third group 324. Therefore, although the confidence score of the question-answer pair exceeds the confidence score, we cannot determine consistency of the question-answer pair 326 because the question-answer pair 326 is not similar to any other question-answer pair included in the plurality of question-answer pairs generated from the respective block of text (or is otherwise an outlier compared to the other questions-answer pairs). Accordingly, the question-answer pair 326 is removed (e.g., denoted by dashed lines) from the dataset that includes the first group 320 of question-answer pairs, the second group 322 of question-answer pairs, and the third group 324 of question-answer pairs and will be used for domain-specific hallucination testing of a language processing machine learning model.

In some embodiments, each question-answer pair within a group (e.g., first group 320, second group 322, third group 324) of question-answer pairs may be compared to determine whether the group of question-answer pairs is reliable. More specifically, the question and answer for a respective-question answer pair within the group may be provided as an input to an entailment model (e.g., the entailment model 118 illustrated in FIG. 1) trained to measure a logical relationship (e.g., entailment) between sentences. The entailment model may, in some embodiments, measure the entailment between the question and the answer and compare the measured entailment to a similarity threshold. If the measured entailment does not satisfy the similarity threshold, the group of question-answer pairs may be deemed unreliable for domain-specific hallucination testing and therefore may be removed (e.g, discarded) from other groups of question-answer pairs.

### Example Text Processing of Source Document

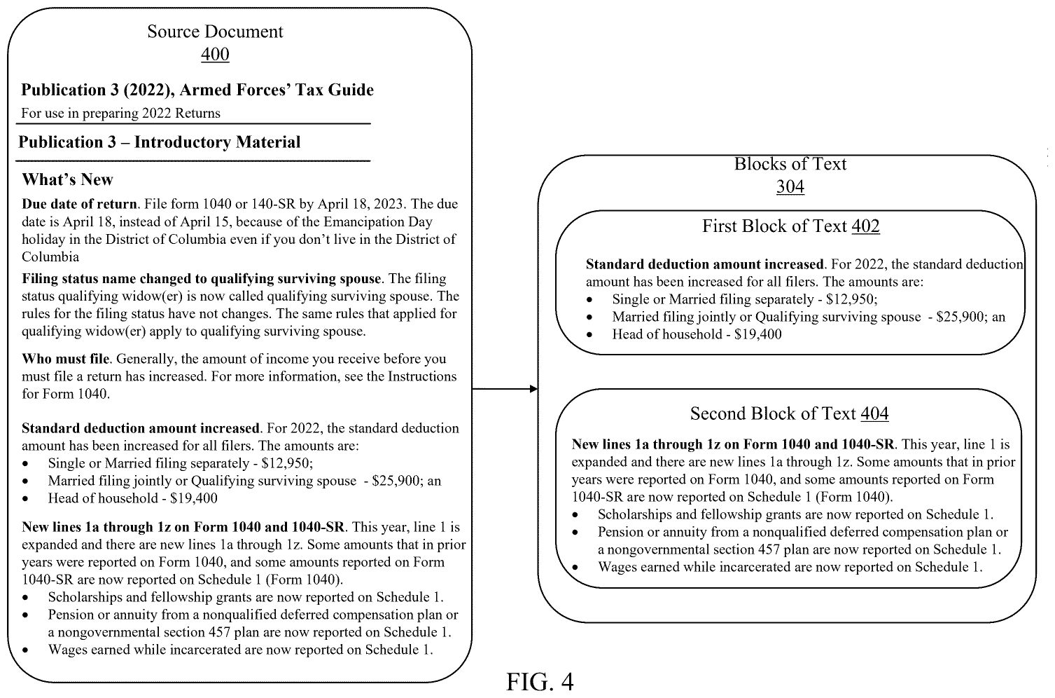

FIG. 4 illustrates a technique for processing content (e.g., natural language text) included in a source document 400 according to some embodiments of the present disclosure. It should be appreciated that the source document 400 may be the source document 302 illustrated in FIG. 3 or one of the source documents 122 illustrated in FIG. 1.

In some embodiments, the source document 400 may include multiple sections/topics. The source document 400 may, for example, include tags, such as text of a particular format (e.g., bolded), to denote a transition from one section/topic of the source document 400 to another section/topic of the source document 400. In some embodiments, the source document 400 may be a web page (e.g., HTML web page) and code (e.g., HTML code) associated with the web page may include tags denoting different sections of the source document 400.

The content (e.g., natural language text) included in the source document 400 may be extracted in blocks, and each block may correspond to a different section/topic of the source document 400. For instance, a first block of text 402 may correspond to a first section/topic of the source document 400 denoted by the bolded text (e.g., titled “Standard deduction amount increased”) and may include the text following the bolded text. A second block of text 404 may correspond to a second section/topic of the source document 400 denoted by the bolded text (e.g., titled “New lines 1a through 1z on Form 1040 and 1040—SR”) and may include content following the bolded text. By limiting the blocks of text to a particular section/topic within the source document 400, question-answer pairs generated by the non-LLM 130 and the LLM 140 may be more consistent and therefore less likely to represent a hallucination.

### Example Question-Answer Pairs Generated by Non-Large Language Model

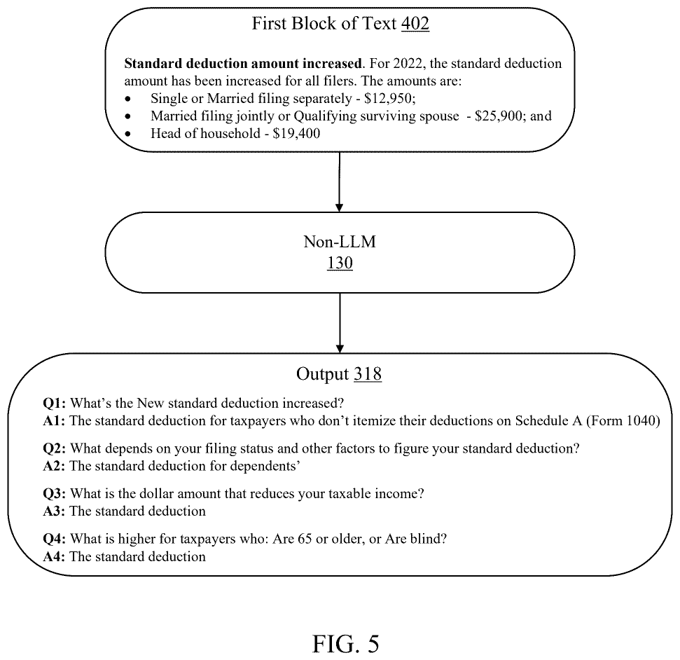

FIG. 5 depicts the non-LLM 130 generating the output 318 from the first block of text 402 extracted from the source document 400 of FIG. 4 according to some embodiments of the present disclosure. As shown, the output 318 may include multiple question-answer pairs (e.g., labeled Q1-A1; Q2-A2; Q3-A3; Q4-A4). Each respective question of the question-answer pairs included in the output 318 of the non-LLM 130 may be formulated based on the text included in the first block of text 402. Likewise, each respective answer of the question-answer pairs included in the output 318 of the non-LLM 130 may be formulated based on the text included in the first block of text 402 and responsive to the respective question of the question-answer pairs.

### Example Question-Answer Pairs Generated by a Large Language Model

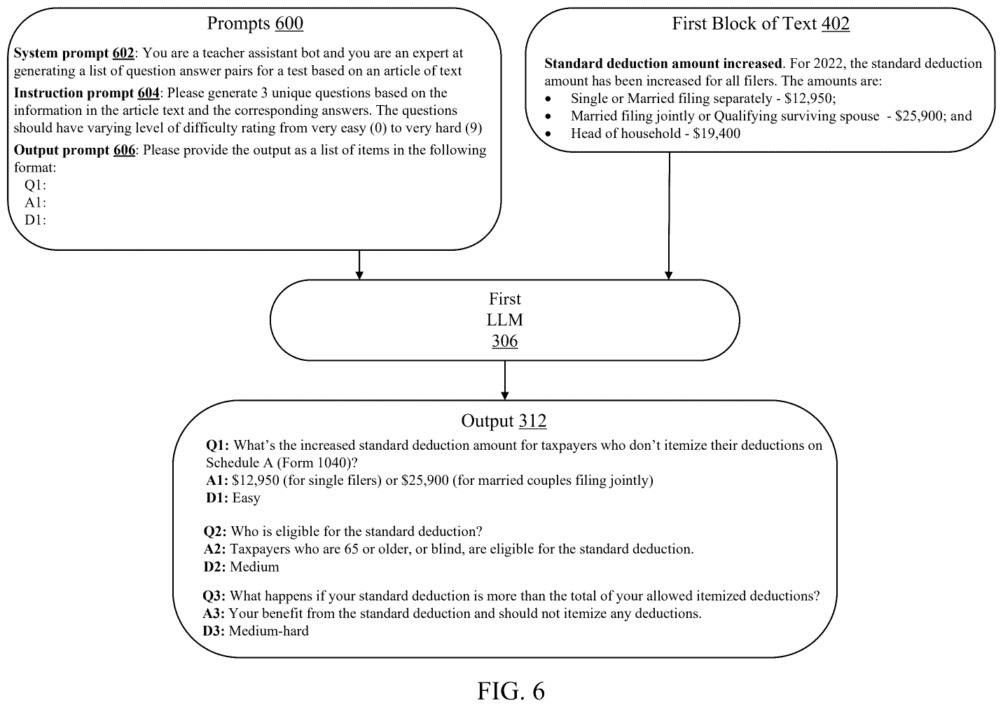

FIG. 6 depicts the first LLM 306 generating the output 312 from the first block of text 402 extracted from the source document 400 of FIG. 4 according to some embodiments of the present disclosure. As shown, the output 312 may include multiple question-answer pairs (e.g., labeled Q1-A1; Q2-A2; Q3-A3). Although only 3 question-answer pairs are depicted, it should be understood that the first LLM 306 may generate additional question-answer pairs from the first block of text 402 extracted from the source document 400. For instance, in some embodiments, the first LLM 306 as well as the other LLMs 140 (e.g., second LLM 308 and third LLM 310 illustrated in FIG. 3) may generate at least five question-answer pairs for each block of text provided as an input to the LLMs 140.

As shown, a plurality of prompts 600 may be provided as an input to the first LLM 306. The plurality of prompts 600 may include a system prompt 602, an instruction prompt 604, and an output prompt 606. The system prompt 602 may include natural language text that provides the first LLM 306 with context regarding what the first LLM 306 is supposed to do with the input (e.g., the first block of text 402). The instruction prompt 604 may include more specific instructions on what the first LLM 306 is supposed to do with the input. For example, the instruction prompt 604 depicted in FIG. 6 provides the first LLM 306 with details regarding the number of question-answer pairs the first LLM 306 is to generate for the input. The instruction prompt 604 also includes instructions to assign a difficulty rating for each respective question-answer pair. In some embodiments, the instruction prompt 504 may include instructions for the first LLM 306 to generate a confidence score for the question included in each respective question-answer pair and a confidence score for the answer included in each respective question-answer pair. The output prompt 606 may include a format of the question-answer pairs. In some implementations, the format for the question-answer pairs may correspond to a JavaScript Object Notation (JSON) format.

In some embodiments, the prompts 600 may instruct the first LLM 306 to generate an unanswerable question using a question from one of the question-answer pairs generated by the first LLM 306 from the first block of text 402. An example of an unanswerable question may be “What will tax laws be like in the year 2030?”

To generate an unanswerable question, an entity (e.g., name, object) included in the question of a generated question-answer pair may be swapped with another entity. Alternatively, or additionally, one or more words in the question of the generated question-answer pair may be replaced with its antonym. In this manner, the question of the generated question-answer pair may be modified to be unanswerable to a language processing machine learning model.

Furthermore, the answer of the generated question-answer pair may be modified to become unanswerable. For instance, a data store (e.g., the data store 120 illustrated in FIG. 1) may include a library of boilerplate responses to unanswerable questions. An example answer to an unanswerable question may be “I am sorry. I do not have enough information to answer that question.”

### Example Computing System

FIG. 7 illustrates an example computing system 700 with which embodiments of the disclosure related to automatically generating a dataset of question-answer pairs for domain-specific hallucination testing of language processing machine learning models may be implemented. For example, the computing system 700 may be representative of server 110 of FIG. 1, may perform functionality described above with respect to FIG. 1 and/or may perform the operations 200 of FIG. 2.

The computing system 700 includes a central processing unit (CPU) 702, one or more I/O device interfaces 704 that may allow for the connection of various I/O devices 704 (e.g., keyboards, displays, mouse devices, pen input, etc.) to the computing system 700, a network interface 706, a memory 708, and an interconnect 712. It is contemplated that one or more components of the computing system 700 may be located remotely and accessed via a network 710. It is further contemplated that one or more components of the computing system 700 may include physical components or virtualized components.

The CPU 702 may retrieve and execute programming instructions stored in the memory 708. Similarly, the CPU 702 may retrieve and store application data residing in the memory 708. The interconnect 712 transmits programming instructions and application data, among the CPU 702, the I/O device interface 704, the network interface 706, the memory 708. The CPU 702 is included to be representative of a single CPU, multiple CPUs, a single CPU having multiple processing cores, and other arrangements.

Additionally, the memory 708 is included to be representative of a random access memory or the like. In some embodiments, the memory 708 may include a disk drive, solid state drive, or a collection of storage devices distributed across multiple storage systems. Although shown as a single unit, the memory 708 may be a combination of fixed and/or removable storage devices, such as fixed disc drives, removable memory cards or optical storage, network attached storage (NAS), or a storage area-network (SAN).

As shown, the memory 708 includes a text processing module 720, a question-answer pair generation module 722, an embedding model 724, and an entailment model 726, which are generally representative of the text processing module 112, the question-answer pair generation module 114, the embedding model 116, and the entailment model 118 of FIG. 1.

It is noted that system 700 is included as an example, and certain functionality described with respect to system 700 and/or otherwise described herein may be implemented via more or fewer devices and/or components.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of′ a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automatically generating a dataset of question-answer pairs for domain-specific hallucination testing of generative language processing machine learning models, the method comprising:
extracting natural language text from a domain-specific source document as a plurality of blocks of natural language text;
providing a first block of natural language text of the plurality of blocks of natural language text as an input to each of a plurality of question-answer pair generation models, each of the plurality of question-answer pair generation models configured to generate a plurality of question-answer pairs from the first block of natural language text;
obtaining one or more confidence metrics for each of the plurality of question-answer pairs generated by each of the plurality of question-answer pair generation models;
filtering one or more question-answer pairs included in the plurality of question-answer pairs generated by one or more of the plurality of question-answer pair generation models based, at least in part, on the one or more confidence metrics generated for the one or more question-answer pairs; and
generating a dataset for domain-specific hallucination testing of a generative language processing machine learning model based on the filtering, the dataset comprising question-answer pairs remaining in the plurality of question-answer pairs after the filtering.

2. The method of claim 1, wherein the filtering comprises:
comparing, for each respective question-answer pair, the one or more confidence metrics to one or more threshold confidence metrics;
determining the one or more confidence metrics for one or more question-answer pairs of the plurality of question-answer pairs generated by one or more question-answer pair generation models of the plurality of question-answer pair generation models do not satisfy the one or more threshold confidence metrics based on the comparing; and
removing the one or more question-answer pairs from the plurality of question-answer pairs generated by the one or more question-answer pair generation models.

3. The method of claim 1, wherein the filtering comprises:
providing the plurality of question-answer pairs generated by each of the plurality of question-answer pair generation models to an embedding model configured to generate a plurality of embeddings, each of the plurality of embeddings corresponding to a different question-answer pair;
identifying a plurality of groups of question-answer pairs based on the plurality of embeddings; and
removing one or more question-answer pairs that are not included in any of the plurality of groups of question-answer pairs.

4. The method of claim 3, wherein the filtering further comprises:
providing, for each of the question-answer pairs included a group of the plurality of groups, a respective answer for each the question-answer pairs as an input to an entailment model configured to determine an entailment between two different answers in the group;
receiving, from the entailment model, the entailment between two different answers;
comparing the entailment to a similarity threshold; and
determining whether the two different answers are consistent based on the comparing.

5. The method of claim 4, wherein determining whether the two different answers are consistent based on the comparing comprises:
determining the two different answers are not consistent based on the comparing; and
removing the group of question-answer pairs.

6. The method of claim 1, wherein:
the plurality of question-answer pair generation models comprise a non-LLM; and
the obtaining comprises determining one or more confidence metrics for each of the plurality of question-answer pairs the non-LLM generated from the first block of natural language text; and
the filtering comprises filtering one or more question-answer pairs of the plurality of question-answer pairs generated by the non-LLM based, at least in part, on the one or more confidence metrics determined for the one or more question-answer pairs.

7. The method of claim 1, wherein the domain-specific source document is an unstructured document, and wherein extracting the natural language text from the domain-specific source document as a plurality of blocks of natural language text comprises:
providing the natural language text in the unstructured document as an input to a machine learning model configured to dynamically determine different topics within the natural language text and organize the natural language text into the plurality of blocks of natural language text, each respective block of natural text corresponding to a different topic.

8. The method of claim 1, further comprising:
modifying a question in a question-answer pair generated by a question-answer pair generation model of the plurality of question-answer pair generation models to be an unanswerable question for the generative language processing machine learning model; and
modifying an answer in the question-answer pair so that the modified answer is consistent with an answer the generative language processing machine learning model generates in response to unanswerable questions,
wherein the dataset for the domain-specific hallucination testing includes the question-answer pair including the unanswerable question and the modified answer.

9. The method of claim 8, wherein modifying the question in the question-answer pair to be an unanswerable question comprises:
replacing a word in the question that corresponds to an entity with a word that corresponds to a different entity; and
replacing one or more words in the question with antonyms of the one or more words.

10. The method of claim 1, wherein the plurality of question-answer pair generation models comprise a plurality of large language models (LLMs), and wherein the method further comprises:
providing one or more prompts to each of the plurality of LLMs, the one or more prompts instructing each of the plurality of LLMs to generate the plurality of question-answer pairs from the first block of natural language text, the one or more prompts further instructing each of the plurality of LLMs to generate the one or more confidence metrics for each question-answer pair.

11. The method of claim 1, wherein the plurality of question-answer pair generation models comprise a non-LLM model and a plurality of LLMs.

12. A system comprising:
a memory including computer executable instructions; and
a processor configured to execute the computer executable instructions and cause the system to:
extract natural language text from a domain-specific source document as a plurality of blocks of natural language text;
provide a first block of natural language text of the plurality of blocks of natural language text as an input to each of a plurality of question-answer pair generation models, each of the question-answer pair generation models configured to generate a plurality of question-answer pairs from the first block of natural language text;
obtain one or more confidence metrics for each of the plurality of question-answer pairs generated by each of the plurality of question-answer pair generation models;
filter one or more question-answer pairs included in the plurality of question-answer pairs generated by one or more of the plurality of question-answer pair generation models based, at least in part, on the one or more confidence metrics generated for the one or more question-answer pairs; and
generate a dataset for domain-specific hallucination testing of a generative language processing machine learning model based on the filtering, the dataset comprising question-answer pairs remaining in the plurality of question-answer pairs after the filtering.

13. The system of claim 12, wherein to filter, the processor is configured to execute the computer executable instructions and further cause the system to:
compare, for each respective question-answer pair, the one or more confidence metrics to one or more threshold confidence metrics;
determine the one or more confidence metrics for one or more question-answer pairs of the plurality of question-answer pairs generated by one or more question-answer pair generation models of the plurality of question-answer pair generation models do not satisfy the one or more threshold confidence metrics based on the comparing; and
remove the one or more question-answer pairs from the plurality of question-answer pairs generated by the one or more question-answer pair generation models.

14. The system of claim 12, wherein to filter, the processor is configured to execute the computer executable instructions and further cause the system to:
provide the plurality of question-answer pairs generated by each of the plurality of question-answer pair generation models to an embedding model configured to generate a plurality of embeddings, each of the embeddings corresponding to a different question-answer pair;
identify a plurality of groups of question-answer pairs based on the plurality of embeddings; and
remove one or more question-answer pairs that are not included in any of the plurality of groups of question-answer pairs.

15. The system of claim 14, wherein to filter, the processor is configured to execute the computer executable instructions and further cause the system to:
provide, for each of the question-answer pairs included a group of the plurality of groups, a respective answer for each the question-answer pairs as an input to an entailment model configured to determine an entailment between two different answers in the group;
receive, from the entailment model, the entailment between two different answers;
compare the entailment to a similarity threshold; and
determine whether the two different answers are consistent based on the comparing.

16. The system of claim 15, wherein to determine whether the two different answers are consistent based on the comparing, the processor is configured to execute the computer executable instructions and cause the system to:
determine the two different answers are not consistent based on the comparing; and
remove the group of question-answer pairs.

17. The system of claim 12, wherein:
the domain-specific source document is an unstructured document, and
to extract the natural language text from the domain-specific source document, the processor is configured to execute the computer executable instructions and cause the system to:
provide the natural language text in the unstructured document as an input to a machine learning model configured to dynamically determine different topics within the natural language text and organize the natural language text into the plurality of blocks of natural language text, each respective block of natural text corresponding to a different topic.

18. The system of claim 12, wherein the processor is configured to execute the computer executable instructions and further cause the system to:
modify a question in a question-answer pair generated by a question-answer pair generation model of the plurality of question-answer pair generation models to be an unanswerable question for the generative language processing machine learning model; and
modify an answer in the question-answer pair so that the modified answer is consistent with an answer the generative language processing machine learning model generates in response to unanswerable questions,
wherein the dataset for the domain-specific hallucination testing includes the question-answer pair including the unanswerable question and the modified answer.

19. The system of claim 18, wherein to modify the question in the question-answer pair to be an unanswerable question, the processor is configured to execute the computer executable instructions and further cause the system to:
modify the question in the question-answer pair to be an unanswerable question comprises:
replace a word in the question that corresponds to an entity with a word that corresponds to a different entity; and
replace one or more words in the question with antonyms of the one or more words.

20. A non-transitory computer-readable medium comprising instructions to be executed in a computer system to automatically generate a dataset of question-answer pairs for domain-specific hallucination testing of generative language processing machine learning models, wherein the instructions when executed in the computer system cause the computer system to:
extract natural language text from a domain-specific source document as a plurality of blocks of natural language text;
provide a first block of natural language text of the plurality of blocks of natural language text as an input to each of a plurality of question-answer pair generation models, each of the plurality of question-answer pair generation models configured to generate a plurality of question-answer pairs from the first block of natural language text;
obtain one or more confidence metrics for each of the plurality of question-answer pairs generated by each of the plurality of question-answer pair generation models;
filter one or more question-answer pairs included in the plurality of question-answer pairs generated by one or more of the plurality of question-answer pair generation models based, at least in part, on the one or more confidence metrics generated for the one or more question-answer pairs; and
generate a dataset for domain-specific hallucination testing of a generative language processing machine learning model based on the filtering, the dataset comprising question-answer pairs remaining in the plurality of question-answer pairs after the filtering.
